(19) United States
(12) Patent Application Publication
(10) Pub. No.: US 2025/0267457 A1
(43) Pub. Date: Aug. 21, 2025

(54) TELECOMMUNICATION NETWORK-BASED DIGITAL TOKEN AUTHENTICATION AND SYSTEMS AND METHODS OF THE SAME

(71) Applicant: T-Mobile USA, Inc., Bellevue, WA (US)

(72) Inventors: Marouane Balmakhtar, Fairfax, VA (US); Lyle Walter Paczkowski, Mission Hills, KS (US); Joao Teixeira, Shawnee, KS (US); Robert Zaruba, Overland Park, KS (US)

(21) Appl. No.: 18/581,608

(22) Filed: Feb. 20, 2024

(51) Int. Cl. H04W 12/084; H04W 12/06

(52) U.S. Cl. CPC H04W 12/084; H04W 12/06

(57) ABSTRACT

Systems and methods for authenticating telecommunication network-based digital tokens are disclosed herein. For example, the system can receive a first token associated with a user of a first user device. The system can extract, from a unified data function, first profile information for the user. The system can store, via a network exposure function, the first token and the profile information. The system can obtain, from a second user device, a second token and second profile information. The system can determine whether the first token matches the second token. The system can determine whether the first profile information matches the second profile information. Based on determining that the tokens and the profile information match, the system can transmit, to the second user device, a token authentication message. Based on determining that the tokens and the profile information do not match, the system can transmit an authentication failure message.

### BACKGROUND

Speech synthesis is the artificial production of human speech. A computer system used for this purpose is called a speech synthesizer and can be implemented in software or hardware products. A text-to-speech (TTS) system converts normal language text into speech; other systems render symbolic linguistic representations like phonetic transcriptions into speech. The reverse process is speech recognition.

Speaker recognition is the identification of a person from characteristics of voices. It is used to answer the question, “Who is speaking?” The term voice recognition can refer to speaker recognition or speech recognition. Speaker verification (also called speaker authentication) contrasts with identification, and speaker recognition differs from speaker diarization (recognizing when the same speaker is speaking). Recognizing the speaker can simplify the task of translating speech in systems that have been trained on specific voices, or it can be used to authenticate or verify the identity of a speaker as part of a security process. Speaker recognition uses the acoustic features of speech that have been found to differ between individuals. These acoustic patterns reflect both anatomy and learned behavioral patterns.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram that illustrates a system for authentication of stored tokens associated with users of a telecommunication network.

FIG. 4 is a schematic illustrating identification and matching of signatures associated with tokens for token authentication.

FIG. 5 is a flowchart illustrating a method for authenticating tokens associated with users of a telecommunication network.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In preexisting systems, users of telecommunication systems or other communications platforms may be associated with digital avatars or other multimedia for user identification. For example, a user may include a photo, description, or voice note associated with a user profile on a social networking application, such as an extended reality application (e.g., a metaverse or virtual reality environment). Other users of the network and/or the application may use these avatars for identification of the user. However, in such systems, malicious entities can easily duplicate and regenerate such digital assets, such as through artificial intelligence engines, thereby complicating user profile authentication. For example, a malicious user may generate (e.g., using an LLM, an artificial intelligence voice generator, or an artificial intelligence image generator) a voice note and profile picture that looks similar to another user's information in order to appear as another trustworthy or well-known user within the associated social media application.

Artificial intelligence content detectors may enable preexisting systems to determine whether generated media has been generated through artificial intelligence models (e.g., LLMs). However, such content detectors do not handle situations where media has been directly copied or duplicated from another source. For example, a malicious entity can copy a profile picture or a 3D model of another user's avatar and mimic the user within an associated social media application. As such, preexisting systems may not prevent duplication or deceit within social media networks or other applications with identification verification concerns.

The systems and methods disclosed herein enable registration of digital assets with mobile devices and associated network information, thereby providing a telecommunication network-based method for authenticating digital assets, such as digital avatars, profile pictures, or voice notes. For example, a token authentication system housed on one or more nodes of a telecommunication network core can store a first user's digital asset, such as a profile picture, in a tamper-proof ledger accessible through an associated network exposure function (NEF). In addition to storing the digital asset, the token authentication system can store an indication of network configuration data or other user profile information associated with the first user's mobile device (e.g., as obtained from a user data function (UDF)) within the tamper-proof ledger.

The system can receive an authentication request from another mobile device (e.g., second user) requesting authentication of a given digital asset to ensure that the digital asset is linked to a user claiming to be associated with the digital asset. For example, the second user of a social media application, accessed via the telecommunication network, can view a representation of the digital asset on a user interface, where the representation of the digital asset (e.g., a digital avatar) is claimed to be representative of a first user of the social media application. In some implementations, the token authentication system can obtain information relating to a network configuration for a third user associated with this digital avatar, such as a communication path (e.g., an indication of network nodes involved in transmitting this avatar to the second user from the third user). The second user can subsequently request authentication of the digital avatar to ensure that the third user corresponds to the first user (e.g., that the digital avatar pertains to the claimed user).

For example, in response to receiving this authentication request, the system can extract an associated token from the tamper-proof ledger, through the NEF, and determine whether the digital asset from the third user matches a previously stored digital asset of the first user. Moreover, the system can determine whether a network configuration associated with the authentication request (e.g., an IP address or MAC address associated with the claimed digital asset and/or the third user) is consistent with a stored network configuration for the first user's mobile device. By doing so, the system can detect whether the digital asset is authentic or artificially generated, as well as whether the asset is linked to the associated device registered with the telecommunication network based on the associated network profile information. As such, the system enables authentication of digital assets, such as digital avatars, profile pictures, or voice data, based on network configuration information pertaining to digital assets, thereby improving the security of the system and accuracy of authentication in situations of artificial intelligence-based spoofing or duplication.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

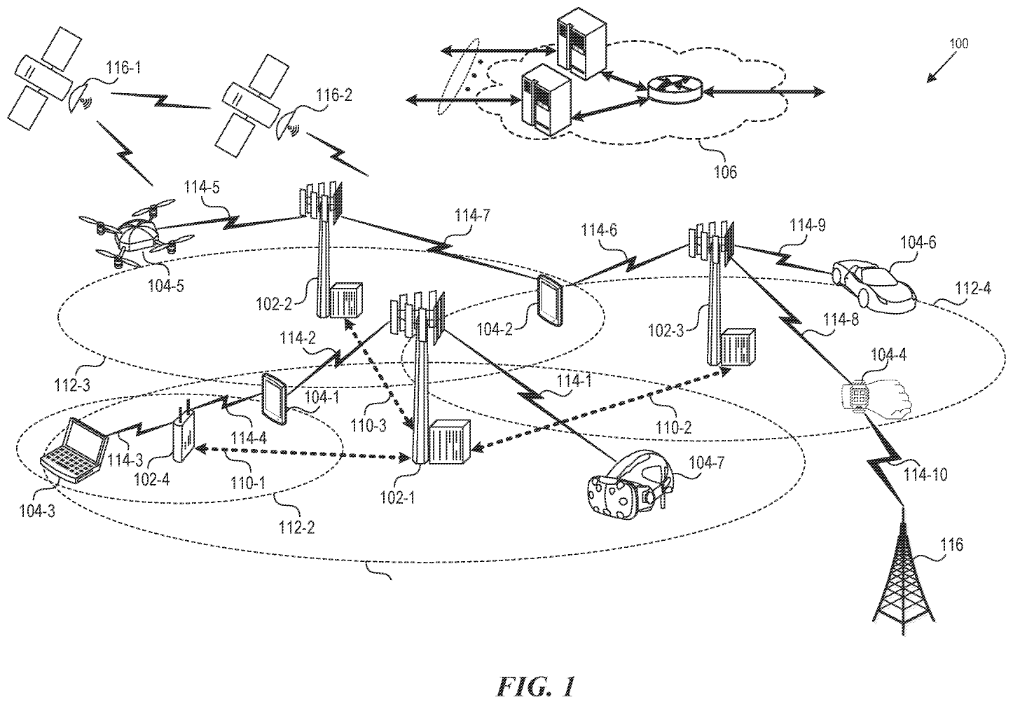

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

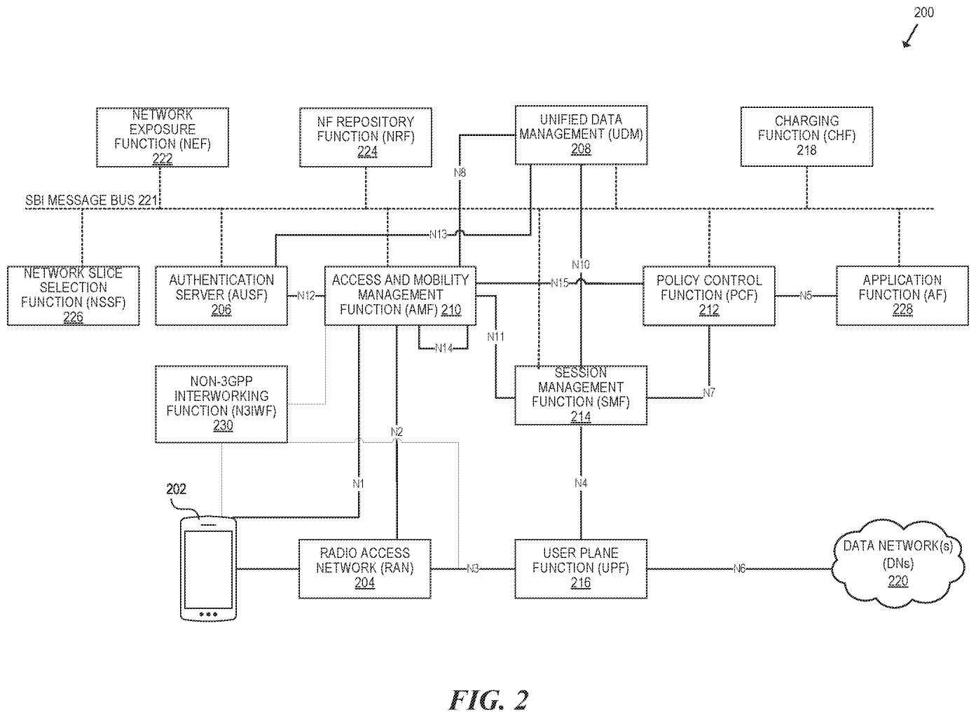

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, a Charging Function (CHF) 218, and a Non-3GPP Interworking Function (N3IWF) 230.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228.

The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

The N3IWF 230 can include a gateway facilitating non-3GPP network access. The gateway enables connections for user equipment (e.g., the wireless device 202) to access the core network and associated network functions via a non-3GPP access network. The N3IWF can be coupled to the UPF by a communication link that includes the N3 link. An IPSec protocol-based user plane tunnel can be created to enable the establishment of a secure communication link between the wireless device 202 and the N3IWF 230. As such, the architecture 200 enables devices without cellular connectivity can access the core network and associated functions.

### Token Authentication System

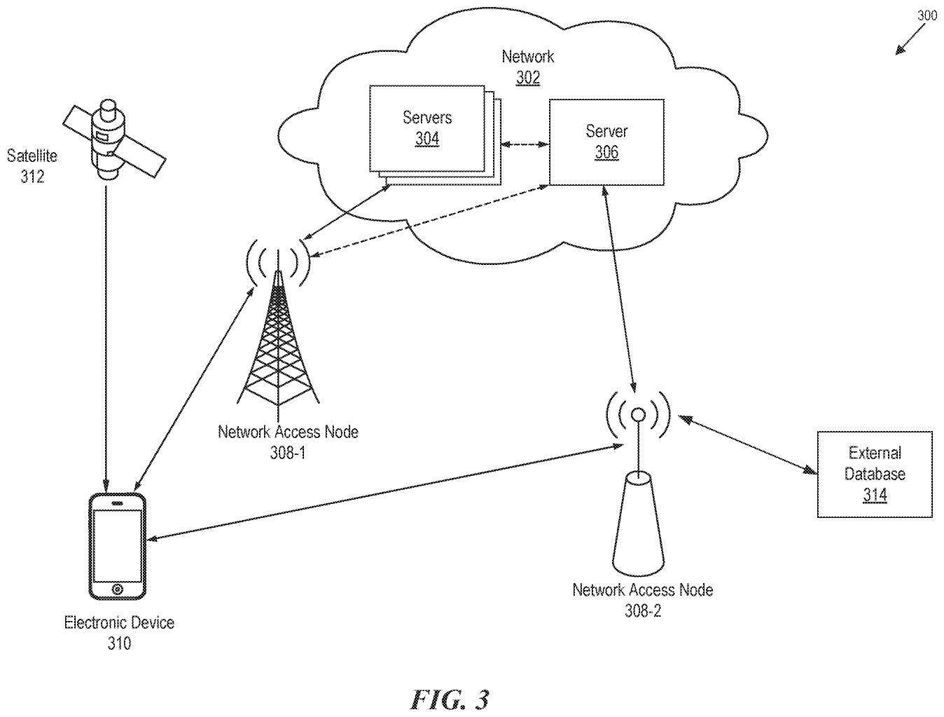

FIG. 3 is a diagram that illustrates a system 300 for authentication of stored tokens associated with users of a telecommunication network. For example, the system 300 can include a token authentication system (e.g., a system associated with the network 302 and/or the architecture 200). The token authentication system can include one or more servers 304 or server 306. For example, the token authentication system can include cloud servers (e.g., network nodes) associated with a 5G core network (e.g., the network 302) and, as such, can include distributed and/or individual computing devices.

The token authentication system can communicate through servers 304 and/or server 306 with network access nodes 308-1 and/or 308-2, which provide links with user equipment, such as an electronic device 310 and/or an external database 314. For example, the electronic device 310 can connect to a satellite 312. In some implementations, the satellite 312 can connect to devices associated with the network 302 (e.g., servers 304 or server 306) through a satellite backhaul. As such, the token authentication system can be configured to communicate with mobile devices and/or external databases through components described in relation to FIG. 2, such as a RAN 204 or an NEF 222, respectively.

The NEF 222 (e.g., associated with network 302) can include a function associated with communications between the 5G network and third-party applications, such as applications or functions associated with the external database 314. For example, the NEF 222 enables secure communication between the 5G network and a database, application, or another third-party system. In some implementations, the NEF 222 includes an application programming interface (API) for communication between a node associated with the 5G network and a third-party database. In some embodiments, the third-party database can include a token database, which may store information relating to tokens (e.g., digital assets, such as digital avatars, images, or voice data associated with users). As such, the NEF 222 enables retrieval and storage of token and profile information associated with users for subsequent user authentication.

The UDM 208 (e.g., associated with network 302) can include one or more network functions, such as unified data functions (UDFs). UDFs may include functions that include user subscription data associated with the network 302 (e.g., the 5G network). A UDF can enable storage or retrieval of subscriber information within the UDR, which may store subscriber profile information, policy, structured, and application data.

In relation to FIG. 2, the UDM 208, through the UDR, can store, extract, and process profile information associated with users. Profile information can include user subscription data, such as identity information, associated devices (e.g., media access control (MAC) addresses or other identifiers), as well as allowances (e.g., network data, talk time, or text message allowances) and billing information. For example, the profile information can include information associated with the electronic device 310 of FIG. 3 and/or an associated user. In some implementations, the profile information can include network configuration information, biometric data associated with users, and/or user credentials (e.g., passwords or usernames associated with the user). Biometric data can include information relating to a user, such as a photograph, 3D model, or fingerprint data associated with a user of the 5G network, including retina scans of a user's eye.

For example, the UDF can store profile information, including user subscription data, within the UDR. User subscription data can include information relating to identities of users, such as user subscription identifiers (e.g., mobile phone numbers, names, or other identifiable information relating to a user's subscription to the telecommunication network). In some implementations, the user subscription data includes information relating to services associated with users, quality of service parameters, authentication details, network configurations available to users, service authorizations, and user session data.

A network configuration can include information associated with a connection between a user equipment and a network. For example, a network configuration can include information relating to settings, policies, flows, or controls associated with the connection. The network configuration can include, for the user, a switch/router configuration, host configuration, software and firewall configurations, network topology, or other information associated with the connection. For example, the network configuration information includes one or more communication paths, which may indicate an indication of devices or communication paths for communication between user equipment and a node associated with the 5G network core. For example, a communication path includes an ordered list of network components (e.g., routers, modems, base stations, core nodes, or other associated devices) through which communications are transmitted or received from a user equipment to a node, including information relating to network access nodes and associated computing devices, such as an indication of a connection between the electronic device 310 and the network access node 308-1. By recording such network path information, the token authentication system enables tracking and authentication of tokens on the basis of profile information, including network configurations, associated with users, thereby providing a way to authenticate the user on the basis of telecommunications subscription data and other associated information.

In some implementations, the AMF 210 can generate, determine, or store information relating to connection and management tasks. For example, the AMF acts as an access point for the 5G core, the RAN control plane, and the user equipment traffic. As such, the AMF 210 can coordinate network handovers between base stations to enable user devices to access the 5G network and any subscribed services, thereby providing connection path information and other network configuration information. Such information can be stored within the UDR, as described above.

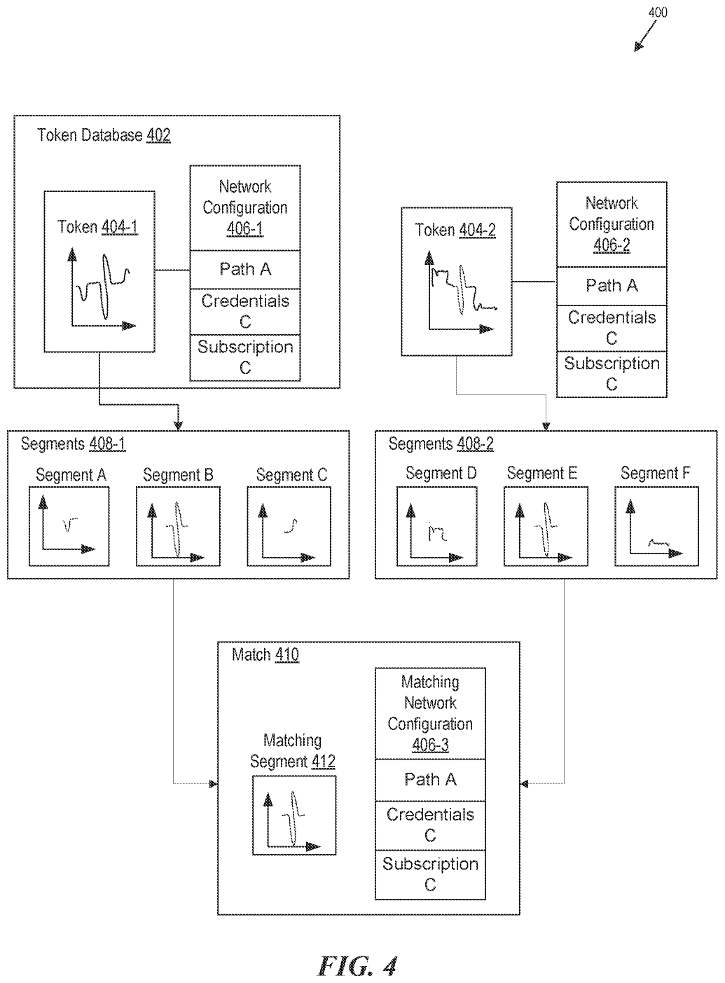

FIG. 4 is a schematic 400 illustrating identification and matching of signatures associated with tokens for token authentication. For example, the token authentication system can obtain a first token from a user and associated profile information (e.g., the token 404-1 and the network configuration 406-1) and store this token and profile information within a token database 402 (e.g., an external database 314, as shown in FIG. 3, through the NEF 222, as shown in FIG. 2).

The token authentication system can receive a request for authentication of a second token (e.g., the token 404-2) associated with further profile information (e.g., the network configuration 406-2). In response to the request for authentication, the token authentication system can analyze tokens and network configurations (or other profile information) to determine whether the tokens match or whether the network configurations match. For example, the token authentication system splits the token 404-1 into segments 408-1, as well as the token 404-2 into segments 408-2. Based on identifying segments that are common to both tokens (e.g., Segment B, as shown in FIG. 4), the token authentication system can determine a match 410, which can include an indication of a matching segment 412 and/or a matching network configuration 406-3, or both. By doing so, the token authentication system enables the determination of whether the second token pertains to a first user based on network profile information and, therefore, that the second token is indicative of an identity or authentication status for the user.

A token can include a digital representation, object, or asset associated with a user. For example, tokens include digital images, avatars, profile pictures, voice recordings, other audio recordings, patterns, videos, or other media associated with a given user. As an illustrative example, a token is an avatar, including a graphical representation of a user or a user's character or persona, such as a 3D model of a person. In some implementations, the token includes a digital avatar in a virtual reality environment, including images, 3D models, or speech data associated with a given user. Additionally or alternatively, a token includes other digital assets, such as representations of digital currency (e.g., cryptocurrency), documents, computer programs, or other assets associated with a user. Malicious entities (e.g., fraudulent entities) may attempt to duplicate, imitate, or reproduce a given token, such as through artificial intelligence generators (e.g., LLMs, image generators, or voice generation algorithms). The token authentication system enables authentication of the source of a given token based on comparison of the tokens, as well as network-related information (e.g., profile information), thereby facilitating evaluation of tokens presented to the token authentication system.

For example, a token includes an audio recording. An audio recording can include information or data in an audio format, such as in an audio file format. For example, audio recordings may include data in MPEG-1 Audio Layer III (MP3), Waveform Audio File Format (WAV), MPEG-4 Part 14 (MP4), or other suitable formats. Such audio recordings can include recordings of real-world sounds, such as speech, noises, or music. Additionally or alternatively, audio recordings can include artificially generated audio data, including artificially or synthetically generated sounds, music, or noises, including voices. In some implementations, the token authentication system can perform segmentation on audio recordings to identify segments, signatures, or other suitable data for identification, analysis, or evaluation of a given token. As an illustrative example, the token authentication system can obtain a first audio recording, represented by the token 404-1, with a given audio waveform. The token authentication system can generate multiple segments 408-1 based on this token, where each segment represents a portion of the waveform associated with the audio recording, including a portion of the audio recording for a corresponding time range. Additionally or alternatively, the token authentication system can execute filtering algorithms, including high-pass, low-pass, or other spectral filtering algorithms, to segment the audio recording in a frequency-wise manner. As shown in FIG. 4, the token authentication system can identify one or more segments that are common to multiple tokens (e.g., Segment B of FIG. 4). By doing so, the token authentication system enables identification of portions of an audio recording that may correspond to an original recording (e.g., as associated with the identity of a user for the original token), thereby enabling authentication of a given token on the basis of similarities in elements, segments, or features of an associated audio recording. In some implementations, the token authentication system can carry out an analogous segmentation and analysis procedure for other types of data, including image data, 3D model data, or video data.

For example, a token includes voice data. Voice data can include audio that includes representations of human voice, such as voice recordings. A voice recording can include speech data, including spoken natural language tokens (e.g., words, phrases, or sentences). For example, a voice recording can include one or more speakers and can include monologues, dialogues, or other expositions of human speech. For example, the token authentication system segments human speech into its component natural language tokens (e.g., segments 408-1) and can compare analogous tokens across multiple tokens to identify whether a speaker for a first token corresponds to a speaker for a second token. In some implementations, the token authentication system can determine whether voice data has been generated artificially or whether it is original to a human speaker. For example, the token authentication system can utilize an artificial intelligence detector to detect whether voice data of a second token is associated with a voice generator, thereby enabling the token authentication to determine whether a given token is associated with real human speech. Thus, the token authentication system can determine the authenticity of tokens based on comparing these tokens with previously stored tokens known to be associated with a given user.

For example, a token includes an image. An image can include a digital photo, illustration, vector file, or any suitable graphical representation. For example, an image can include data in image file formats, such as Portable Network Graphics (PNG), Tag Image File Format (TIFF), Joint Photographic Experts Group (JPEG), Graphics Interchange Format (GIF), Bitmap (BMP), Portable Document Format (PDF), Encapsulated PostScript (EPS), or other suitable file formats. An image can include a representation of a user, such as a profile picture, a profile illustration, or a graphical representation of the user (e.g., of an associated digital avatar). In some implementations, an image, or other tokens in other formats, is associated with a non-fungible token (NFT). For example, an image can include pixelated data or data in a vector format. In some implementations, the token authentication system can segment an image into multiple image segments (e.g., image regions or image objects), where each image segment includes a set of pixels or vectors associated with the image. For example, the token authentication system can identify features, such as objects, edges, or boundaries, based on regions of a given image. For example, pixels within a given image segment can include similarities with respect to a characteristic or computed property, such as color, intensity, or texture. The token authentication system can compare image segments across tokens to determine commonalities or similarities. For example, the token authentication system can determine that the image includes a signature within an image segment in an image associated with a given user and can determine that another token includes the same signature (e.g., the same graphical feature). Based on this determination, the token authentication system can generate an indication that two tokens are likely associated with the same features and, therefore, that they likely represent the same user.

For example, a token includes a 3D model or a four-dimensional (4D) model. A 3D model can include a representation of an object, feature, or element in three dimensions. For example, a 3D model includes a coordinate-based or other suitable mathematical representation of a surface of an object (inanimate or living). A 3D model can represent a collection of points in 3D space connected by geometric entities, such as triangles, lines, curved surfaces, or other data. In some embodiments, surfaces can include textures, colors, or other information. In some embodiments, a 3D model can include various 3D components, such as representations of heads, limbs, or other features. A 3D model can include or be a part of a digital avatar associated with a user, such as in a virtual reality environment (e.g., a metaverse). In some implementations, a 3D model is associated with user-specific voice data, audio recordings, images, or videos. A token can include a 4D model that includes a 3D model and a dimension of time (e.g., representing animations, changes, or transformations over time). Such a 4D representation or token can enable dynamic alterations or movements associated with a 3D model, capturing an evolving or time-based aspect to the token's content. Three-dimensional models can include computer-aided development (CAD) file formats or other suitable formats, such as object (OBJ), GL Transmission Format (gITF), or Universal Scene Descriptor (USD) formats. As such, 3D models can provide information associated with users and can be used to represent a user in a social network or a virtual reality environment. The token authentication system can determine whether a first 3D model matches a second 3D model associated with a user. For example, the token authentication system can determine whether components, parts, or textures of a first 3D model match analogous elements of a second 3D model to determine whether the corresponding tokens match. By doing so, the token authentication system can determine whether digital avatars that include 3D models are associated with one another, even in situations where the 3D models are deformed, modified, or changed (as in an animation of a movement of a 3D model). As such, the token authentication system enables determinations of whether a given token matches a previously stored token on the basis of similarities or differences between associated 3D models.

For example, a token includes segments. A segment can include a portion of a token or associated media. For example, a segment can include a temporal segment of an audio file (e.g., audio or voice data associated with a given time period). A segment can include a portion or analysis of an audio file based on frequency ranges (e.g., a spectral segment of the audio file). In some embodiments, a segment includes a portion of an image, such as a collection of pixels, vectors, or elements within the image with common characteristics or features. For example, the segment can include regions of interest associated with elements of the image that may identify a given user or identify a token associated with the user. A segment can include a part of a video file, including video data associated with a given time period. Additionally or alternatively, audio and image data associated with the video file can be separated and analyzed as separate entities, as described above. A segment can include portions of a 3D model, such as components, surfaces, textures, or other elements of a given 3D model. For example, the segment includes a surface representing a limb, extremity, or facial element of a given user's digital avatar. By separating a token into segments, the token authentication system enables comparison of tokens to determine whether a given token corresponds to a given user. For example, the token authentication system can determine whether an audio recording includes segments of speech that are similar to segments of speech in another audio recording to determine that it is likely that both audio recordings correspond to the same user.

For example, a token includes a signature. A signature can include an element, characteristic, or feature of a given token that may be associated with or may be used to identify a user. A signature can include a component, element, or characteristic of a suitable format. For example, a voice signature can include a portion (e.g., a segment) of a voice recording that includes a characteristic that is unique to a given user or suggestive of the identity of the user. The voice signature can include an intonation, a natural language token as spoken by a user, or another component of the voice recording that indicates the user's identity. As an illustrative example, the token authentication system can determine that a given segment of a first token includes a biometric characteristic (e.g., a voice print) of a user. The token authentication system can detect that a second token includes the same biometric characteristic and, therefore, that both tokens include speech or audio data from the same user. In some implementations, the signature can include an image signature, such as a feature, element, or characteristic of an image (e.g., an image segment) that is indicative of a user's identity. For example, an image signature includes an aberration, image artifact (e.g., a missing pixel), or another suitable image characteristic that is unique to a given user or the user's media. Signatures can include audio signatures, video signatures, or other characteristics of media that are indicative of a user's identity. By identifying signatures (e.g., corresponding to segments), the token authentication system improves the accuracy of user authentication by enhancing its ability to identify media that is likely to originate from the same source or user.

Based on an evaluation of tokens and/or profile information, the token authentication system can generate a token authentication message. For example, the token authentication system can determine that differing tokens include matching signatures or segments and that associated network configurations (e.g., profile information) are consistent with each other. Based on this determination, the token authentication system can generate a token authentication message that includes an indication of a match. For example, the token authentication message can include an indication that the tokens likely originated from the same user based on the identification of similar features (e.g., segments or signatures) within the tokens, as well as a determination of similar network environments associated with the two tokens. For example, as shown in FIG. 4, the token authentication system can determine that the two tokens share a similar communication path, such as Path A, identical user credentials, such as Credentials C, or identical subscription to the telecommunication network, such as Subscription C. Based on determining matching profiles and matching tokens, the token authentication system can generate an icon, a flag, or another semaphore associated with the authentication, thereby signaling to other users of a given social network application (e.g., an extended reality application, such as a metaverse) that a token corresponds to a verified user.

Based on the evaluation of tokens and/or profile information, the token authentication system can generate an authentication failure message. An authentication failure message can include an indication of an absence of a match between tokens or profile information associated with these tokens. For example, the token authentication system can generate a message indicating that no segments or signatures are common to a first token and a second token. For example, upon detecting that a given token is likely generated artificially, the token authentication system can generate a message for display on a user device that the token is likely artificially generated and, therefore, unlikely to correspond to a verified token stored on a token database. Additionally or alternatively, the token authentication system can generate a message indicating that network paths, credentials, or subscriptions associated with two tokens are not consistent with each other and, therefore, that the tokens likely originate from different users (e.g., potentially indicating fraudulent use of a token). For example, the token authentication system can generate an indication, such as a flag, a graphical icon, or another semaphore associated with the authentication failure, thereby warning other users of an associated social network application that a given token likely does not correspond to a claimed user. By doing so, the token authentication system discourages fraudulent behavior, such as duplication or spoofing of user profiles and associated tokens, thereby improving the security of the associated telecommunication network.

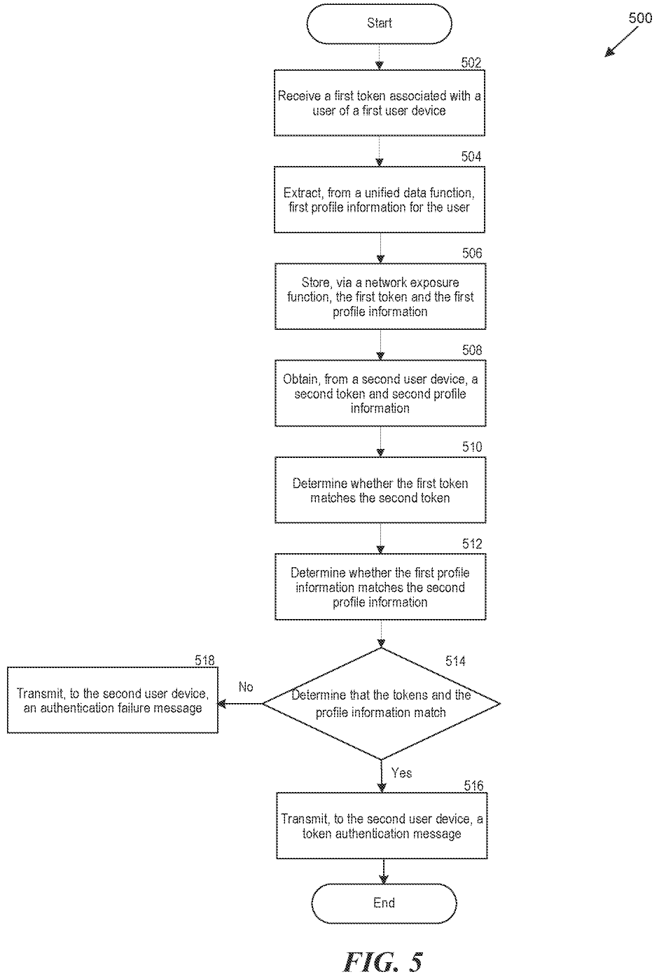

FIG. 5 is a flowchart illustrating a method 500 for authenticating tokens associated with users of a telecommunication network. For example, method 500 enables the token authentication system to evaluate whether tokens, such as digital avatars, correspond to users of an associated telecommunication network based on stored token data and user profile information. As such, the token authentication system enables users to obtain information relating to the authenticity and source of tokens, thereby improving the security and safety of associated communication systems (e.g., social media networks).

At operation 502, the token authentication system can receive a first token for a user. For example, the token authentication system receives, from a first user device of a user, a first token associated with the user. The token can include information, data, digital assets, or representations associated with the user, such as a profile picture, a digital avatar, a 3D model associated with the user, an audio recording, or a voice recording (e.g., of the user speaking). As such, the token authentication system can receive information serving as an identifier of the user. By receiving such information, the token authentication system can register the user and associated credential information to enable subsequent authentication of the user's assets, such as on a social media platform, to ensure the security of the system and prevent fraudulent representations of users based on duplication or reproduction of the users' assets by malicious entities.

At operation 504, the token authentication system can extract first profile information for the user. For example, the token authentication system extracts, from a unified data function (UDF), first profile information for the user. The profile information can include information relating to a user's mobile device and its connection with a telecommunication system. For example, the profile information can include network configuration data associated with the user and/or the first token, such as information relating to the communication paths of the user, network subscription data, or other credential information associated with the user. To illustrate, the profile information can include information associated with a UDF and/or a UDM, such as policy information, subscription information, or other information extracted from a telecommunication network's AMF. The profile information can include network configuration information, including device identifiers associated with mobile devices linked to given tokens, biometric data associated with the user (e.g., a retina scan), and/or user credentials (e.g., a password, username, or another authentication element associated with users and associated tokens). In some implementations, the profile information includes a communication path associated with the token. For example, the communication path can include an indication of a transmission path between a node associated with the telecommunication system and the user device. As such, the token authentication system can obtain information associated with the first token (and/or a device associated with the first token). Thus, the token authentication system can further evaluate this profile information and the tokens to improve the accuracy of token authentication in order to mitigate the incidence of fraudulent theft or reproduction of user-created tokens.

At operation 506, the token authentication system can store the first token and the first profile information. For example, the token authentication system stores, via a network exposure function (NEF), the first token and the first profile information. The token authentication system can communicate with a third-party database (e.g., a token database) to store information relating to the token and the source of the token (e.g., information relating to the subscription or network configuration of the user associated with the token). As such, by storing such information in a database accessible to the telecommunication network, the token authentication system can authenticate subsequently received tokens based on both the nature of the token as well as an associated profile (e.g., network configuration) associated with this profile in light of the stored tokens within the token database. By doing so, the token authentication system can confirm whether a given token is associated with a user claiming to be associated with the token (e.g., within a metaverse or another extended reality system) or whether the token may be artificially generated or is associated with a user that differs from the user that is claimed to be linked with the token.

At operation 508, the token authentication system can obtain a second token and second profile information. For example, the token authentication system obtains, from a second user device, a second token and second profile information associated with the second token. As an illustrative example, the token authentication system can receive an authentication request from a user of a device that includes a token to be authenticated. For example, an associated telecommunication system can cause a mobile device for a second user to display a token (e.g., a digital avatar) along with a claim that the token is associated with the first user (e.g., the user that is associated with a previously stored token). The second user can transmit, to the token authentication system, a request to authenticate this token by comparing this token with the previously stored token. Moreover, the token authentication system can determine profile information (e.g., a network configuration) associated with a third mobile device that corresponds to the token to be authenticated (e.g., a mobile device associated with a user claiming to possess the previously stored token). Based on comparing this profile information with profile information associated with the previously stored token, the token authentication system enables authentication of the token to ensure that the token corresponds with the previously stored token and that a corresponding network configuration or other profile information is consistent with this determination.

At operation 510, the token authentication system can determine whether the first token matches the second token. For example, the token authentication system determines, via the NEF, whether the first token matches the second token. To illustrate, the token authentication system can retrieve the first token (e.g., a first digital avatar) from a token database through an NEF associated with the telecommunication network. The token authentication system can compare the first token with the second token (e.g., the token to be authenticated) to ensure that the tokens match. The token authentication system can determine that a voice signature of the first token (e.g., a first voice recording) matches a voice signature of the second token (a second voice recording) or that a segment of the first token matches a segment of the second token. By doing so, the token authentication system can determine whether the tokens are associated with the same user (e.g., through identification of a user with similar or identical voice features), thereby improving the security and confidence in a token displayed on an associated social media network or extended reality environment associated with the telecommunication network.

In some implementations, the token authentication system determines whether the first token matches the second token by identifying and/or determining signatures associated with the tokens. For example, the token authentication system can determine a first signature associated with the first token. The token authentication system determines a second signature associated with the second token. The token authentication system can determine, based on a match between the first signature and the second signature, that the second token is associated with the user. As an illustrative example, the token authentication system can identify a signature by determining a voice element unique to the user based on the first token (e.g., a voice recording of the user). For example, the voice element includes a natural language token (e.g., a word, phrase, or sentence) by the user. The token authentication system can determine whether the second token (e.g., a second voice recording) includes the same voice element. As such, the token authentication system enables determination of whether the identity of a user associated with a token is consistent across multiple tokens, thereby enabling accurate authentication of the source of the token.

In some implementations, the token authentication system determines whether the first token matches the second token by identifying and/or determining segments associated with the tokens. For example, the token authentication system segments the first token to generate a first segment. The token authentication system can segment the second token to generate a second segment. The token authentication system can determine, in response to determining that the first segment matches the second segment, that the second token is associated with the user. As an illustrative example, the token authentication system segments first voice data associated with the first token into various segments and carries out an analogous process with second voice data associated with the second token to generate another set of segments. The token authentication system can determine that a first segment of the first voice data matches a second segment of the second voice data. For example, the token authentication system can determine that a word, phrase, or sentence said by a user associated with the first voice recording matches a word, phrase, or sentence said by a user associated with the second voice recording. Based on determining a match between these segments, the token authentication system can determine that the tokens match (e.g., are likely associated with the same user). For example, acoustic qualities of certain words, phrases, or sentences may be common to two separate voice recordings recorded by the same user. Thus, by segmenting tokens, the token authentication system enables accurate matching of elements of the tokens, even if the tokens as a whole differ.

At operation 512, the token authentication system can determine whether the first profile information matches the second profile information. For example, the token authentication system determines, via the NEF, whether the first profile information matches the second profile information. To illustrate, the token authentication system can retrieve the first profile information from the token database, via the NEF, where the first profile information can include information associated with the network connection between a user device linked to the first token and a node associated with the telecommunication network. For example, the token authentication system can retrieve a network path associated with the first token, as well as any suitable user credentials or subscription data. The token authentication system can compare this information with profile information associated with the second token. For example, the second token may be associated with a third mobile device (e.g., uploaded to a social media application from the third mobile device). As such, the second profile information can include network configuration information, user subscription information, or user credentials associated with the third mobile device. By comparing the first profile information with the second profile information, the token authentication system improves the accuracy of authenticity determinations associated with digital tokens, such as digital avatars, by leveraging information about the network connections associated with the given tokens. As such, the token authentication system enables mitigation of malicious duplication or reproduction of digital tokens.

In some implementations, the token authentication system determines a match between the first profile information and the second profile information based on comparing respective communication paths. For example, the token authentication system determines, based on the first profile information, a first communication path for the first user device. The token authentication system can query the UDF for communication path information for a third user device associated with the second profile information, wherein the communication path information is associated with an access and mobility management function (AMF). In response to the query for communication path information, the token authentication system can receive an indication of a second communication path between a node associated with the telecommunication system and the third mobile device. The token authentication system can compare the first communication path and the second communication path to determine that the first profile information matches the second profile information. As an illustrative example, the token authentication system can determine communication nodes involved in data transmission between a mobile device associated with a given token and an associated mobile device by querying an AMF associated with the telecommunication network. For example, the token authentication system determines, for the given mobile device, an ordered list of associated network access nodes (e.g., as part of the radio access network) and/or nodes associated with the telecommunication network core. By doing so for each suitable token, the token authentication system can determine whether such tokens were generated in similar network environments, thereby enabling authentication of the source of the tokens (e.g., to determine whether the same user generated the first token and the second token).

In some implementations, the token authentication system determines a match between the first profile information and the second profile information based on comparing respective subscriber identifiers. For example, the token authentication system determines a first user subscription identifier based on the first profile information. The token authentication system can query the UDF to determine a second user subscription identifier associated with a third mobile device associated with the second profile information. The token authentication system can compare the first user subscription identifier with the second user subscription identifier to determine whether the first profile information matches the second profile information. As an illustrative example, the token authentication system can determine an identifier associated with a user's subscription to the telecommunication network (e.g., a mobile number or an account identifier associated with the user). The token authentication system can determine this identifier as pertaining to the first token and the second token and determine whether the identifiers are consistent with one another. By doing so, the token authentication system enables determination as to whether the same user generated the first token and the second token, thereby improving the accuracy of authentication of user-generated tokens.

At operation 514, the token authentication system can determine whether the tokens and the profile information match and generate messages to users accordingly. For example, the token authentication system can determine whether both tokens (e.g., the first token and the second token) match each other, whether profile information associated with both tokens matches, and/or whether both these conditions are met. As an illustrative example, the token authentication system can determine that the first token and the second token include the same voice signature and, therefore, that there is a match. However, the token authentication system can determine that the first profile information does not match the second profile information; for example, the token authentication system can determine that a network path associated with the first mobile device (e.g., the user with the original token) is different from a network path associated with the third mobile device (e.g., associated with the second token). Based on this determination, the token authentication system can determine, for example, that the second token may be a duplicate or may be derived from the first token but that the user claiming to be associated with the second token differs from the user associated with the first token. To illustrate, the token authentication system can determine that the second token is a fraudulently presented version of the first token (e.g., a copy presented by another user).

Additionally or alternatively, the token authentication system can determine that the first token and the second token do not include any common features, signatures, or segments, in addition to determining that an inconsistency exists in the corresponding profile information. For example, the token authentication system can determine that the first token is a real voice recording of the user, while the second token is an artificial intelligence-generated version of the user's voice, differing in voice signature. Based on this determination, the token authentication system can determine that the second token is likely to be a fraudulent representation of the first token and that, for example, the user associated with the first token is unlikely to have generated the second voice recording.

Additionally or alternatively, the token authentication system can determine that the first token and the second token do not include any common features, signatures, or segments, while the first profile information matches the second profile information. For example, the token authentication system can determine that the second token, while likely associated with the same user, is a different representation of the user (e.g., in a different format or a different object). Based on this determination, the token authentication system can determine to update the token database to include the second token, thereby enabling dynamic registration of tokens when such tokens are determined to be associated with a given user.

At operation 516, the token authentication can transmit a token authentication message in response to determining that the tokens match and that the profile information matches. For example, in response to determining that the first token matches the second token and determining that the first profile information matches the second profile information, the token authentication system transmits, to the second user device, a token authentication message. As an illustrative example, the token authentication system can determine to transmit an indication of authentication of the second token if the tokens and profile information match, as described above. For example, the token authentication system can generate a flag, semaphore, or another indication on a user interface associated with the second mobile device, where the indication describes that the second token likely corresponds to a user associated with the first token. For example, the token authentication system can generate a green checkmark or another affirmative indication on a screen, set of virtual reality goggles, or another user interface to indicate that a given digital avatar or voice recording is associated with a previously stored digital avatar and corresponds to the same associated user of the telecommunication network (e.g., as verified by network configuration, subscription, or credential data). As such, the token authentication system can improve user confidence in displayed tokens, thereby improving the security and user-friendliness of the system.

At operation 518, the token authentication system can transmit an authentication failure message in response to determining that the tokens do not match or that the profile information does not match. For example, in response to determining that either the first token does not match the second token or that the first profile information does not match the second profile information, the token authentication system transmits, to the second user device, an authentication failure message. As an illustrative example, the token authentication system can generate a flag, semaphore, or another indication on a user interface associated with the second mobile device, where the indication describes an inconsistency between the first token and the second token. For example, the authentication failure message includes an indication that the first token does not correspond to the second token or that the second token is likely a reproduction or duplication of the first token by another user (e.g., associated with another mobile device or user subscription). As such, the token authentication system can prevent or mitigate situations where a given token is likely misrepresented by a malicious entity, thereby improving system security.

In some implementations, the token authentication system can terminate a connection between the telecommunication network and a mobile device based on an authentication failure. For example, in response to determining that either the first token does not match the second token or that the first profile information does not match the second profile information, the token authentication system terminates a connection to a third mobile device associated with the second token. As an illustrative example, the token authentication system determines that, based on a failure to determine that the tokens match (e.g., that acoustic signatures associated with the tokens match) or on a failure to determine that the profile information does not match (e.g., that network configurations associated with the tokens match), the token authentication system can determine to terminate a connection to a mobile device associated with a user associated with the second token. For example, the token authentication system can identify a mobile device associated with a user attempting to duplicate or reproduce tokens associated with the first user (e.g., a third user associated with the second token). Based on determining that the second token is indicative of fraud or misrepresentation, the token authentication system can determine to terminate a connection to this mobile device and/or terminate access to the associated application (e.g., a social media network). By doing so, the token authentication system can prevent continued access to the associated system for entities determined to be malicious.

### Computer System

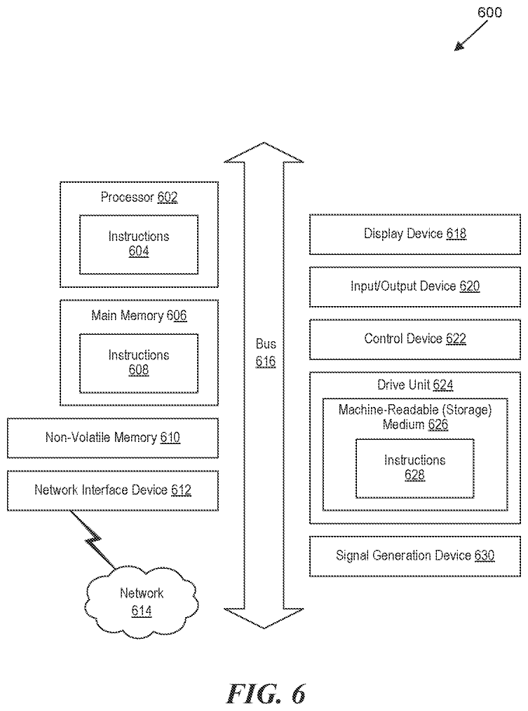

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A fifth generation (5G) telecommunication system comprising:
at least one hardware processor; and
at least one non-transitory memory storing instructions, which, when executed by the at least one hardware processor, cause the 5G telecommunication system to:
receive, from a first mobile device of a user, first voice data associated with the user;
extract, from a unified data function (UDF), a first network configuration for the user;
store, via a network exposure function (NEF), the first voice data and the first network configuration;
obtain, from a second mobile device, second voice data and a second network configuration associated with the second voice data;
determine, via the NEF, whether a first acoustic signature of the first voice data matches a second acoustic signature of the second voice data;
determine, via the NEF, whether the first network configuration matches the second network configuration;
in response to determining that the first acoustic signature matches the second acoustic signature and determining that the first network configuration matches the second network configuration, transmit, to the second mobile device, an indication that the second voice data corresponds to the user; and
in response to determining that either the first acoustic signature does not match the second acoustic signature or that the first network configuration does not match the second network configuration,
transmit, to the second mobile device, an indication that the second voice data is artificially generated.

2. The 5G telecommunication system of claim 1, wherein the instructions for determining that the first acoustic signature matches the second acoustic signature cause the 5G telecommunication system to:
determine the first acoustic signature associated with a first speaker of the first voice data;
determine the second acoustic signature associated with a second speaker of the second voice data; and
determine, based on a match between the first acoustic signature and the second acoustic signature, that the second voice data is associated with the user.

3. The 5G telecommunication system of claim 1, wherein the instructions for determining that the first acoustic signature matches the second acoustic signature cause the 5G telecommunication system to:
segment the first voice data to generate a first voice segment;
segment the second voice data to generate a second voice segment; and
determine, in response to determining that the first voice segment matches the second voice segment, that the second voice data is associated with the user.

4. The 5G telecommunication system of claim 1, wherein the instructions for determining that the first network configuration matches the second network configuration cause the 5G telecommunication system to:
determine, based on the first network configuration, a first communication path for the first mobile device;
query the UDF for communication path information for a third mobile device associated with the second network configuration,
wherein the communication path information is associated with an access and mobility management function (AMF);
in response to the query for communication path information, receive an indication of a second communication path between a node associated with the 5G telecommunication system and the third mobile device; and
compare the first communication path and the second communication path to determine that the first network configuration matches the second network configuration.

5. The 5G telecommunication system of claim 1, wherein the instructions for determining whether the first network configuration matches the second network configuration cause the 5G telecommunication system to:
determine a first user subscription identifier associated with the first network configuration;
query the UDF to determine a second user subscription identifier associated with the second network configuration; and
compare the first user subscription identifier with the second user subscription identifier to determine whether the first network configuration matches the second network configuration.

6. The 5G telecommunication system of claim 1, wherein the instructions cause the 5G telecommunication system to, in response to determining that either the first acoustic signature does not match the second acoustic signature or that the first network configuration does not match the second network configuration, terminate a connection to a third mobile device associated with the second voice data.

7. The 5G telecommunication system of claim 1, wherein the first voice data is associated with an image, a three-dimensional model, an audio recording, a digital avatar, or a voice recording.

8. The 5G telecommunication system of claim 1, wherein the first network configuration comprises a device identifier, biometric data including a retina scan, or user credentials.

9. The 5G telecommunication system of claim 1, wherein the first network configuration includes an indication of a communication path between a node associated with the 5G telecommunication system and the first mobile device.

10. A non-transitory, computer-readable storage medium comprising instructions recorded thereon, wherein the instructions, when executed by at least one data processor of a telecommunication system, cause the telecommunication system to:
receive, from a first user device of a user, a first token associated with the user;
extract, from a unified data function (UDF), first profile information for the user;
store, via a network exposure function (NEF), the first token and the first profile information;
obtain, from a second user device, a second token and second profile information associated with the second token;
determine, via the NEF, whether the first token matches the second token;
determine, via the NEF, whether the first profile information matches the second profile information;
in response to determining that the first token matches the second token and determining that the first profile information matches the second profile information, transmit, to the second user device, a token authentication message; and
in response to determining that either the first token does not match the second token or that the first profile information does not match the second profile information, transmit, to the second user device, an authentication failure message.

11. The non-transitory, computer-readable storage medium of claim 10, wherein the instructions for determining that the first token matches the second token cause the telecommunication system to:
determine a first signature associated with the first token;
determine a second signature associated with the second token; and
determine, based on a match between the first signature and the second signature, that the second token is associated with the user.

12. The non-transitory, computer-readable storage medium of claim 10, wherein the instructions for determining that the first profile information matches the second profile information cause the telecommunication system to:
determine, based on the first profile information, a first communication path for the first user device;
query the UDF for communication path information for a third user device associated with the second profile information,
wherein the communication path information is associated with an access and mobility management function (AMF);
in response to the query for communication path information, receive an indication of a second communication path between a node associated with the telecommunication system and the third user device; and
compare the first communication path and the second communication path to determine that the first profile information matches the second profile information.

13. The non-transitory, computer-readable storage medium of claim 10, wherein the instructions for determining whether the first profile information matches the second profile information cause the telecommunication system to:
determine a first user subscription identifier based on the first profile information;
query the UDF to determine a second user subscription identifier associated with a third user device associated with the second profile information; and
compare the first user subscription identifier with the second user subscription identifier to determine whether the first profile information matches the second profile information.

14. The non-transitory, computer-readable storage medium of claim 10, wherein the first token comprises an image, a three-dimensional model, an audio recording, a digital avatar, or a voice recording.

15. The non-transitory, computer-readable storage medium of claim 10, wherein the first profile information comprises a device identifier, biometric data including a retina scan, or user credentials.

16. The non-transitory, computer-readable storage medium of claim 10, wherein the first profile information includes an indication of a communication path between a node associated with the telecommunication system and the first user device.

17. A method comprising:
receiving, from a first user device of a user, a first token associated with the user;
extracting, from a unified data function (UDF) of a telecommunication system, a first profile information for the user;
storing, via a network exposure function (NEF) of the telecommunication system, the first token and the first profile information;
obtaining, from a second user device, a second token and second profile information associated with the second token;
determining, via the NEF, whether the first token matches the second token;
determining, via the NEF, whether the first profile information matches the second profile information;
in response to determining that the first token matches the second token and determining that the first profile information matches the second profile information, transmitting, to the second user device, a token authentication message; and
in response to determining that either the first token does not match the second token or that the first profile information does not match the second profile information, transmitting, to the second user device, an authentication failure message.

18. The method of claim 17, wherein the first token comprises an image, a three-dimensional model, an audio recording, a digital avatar, or a voice recording.

19. The method of claim 17, wherein the first profile information comprises a device identifier, biometric data including a retina scan, or user credentials.

20. The method of claim 17, wherein the first profile information includes an indication of a communication path between a node associated with the telecommunication system and the first user device.
